(19) United States
(12) Patent Application Publication
(10) Pub. No.: US 2026/0200028 A1
(43) Pub. Date: Jul. 16, 2026

(54) MACHINING TRAJECTORY DISPLAY SYSTEM

(71) Applicant: TOYOTA JIDOSHA KABUSHIKI KAISHA, Toyota-shi (JP)

(72) Inventors: Tetsuro MATSUDA, Toyota-shi (JP); Yusuke KOBAYASHI, Toyota-shi (JP); Ryotaro TANAKA, Nissin-shi (JP); Yasuo KONDOU, Tokoname-shi (JP); Suguru TOYA, Toyota-shi (JP)

(73) Assignee: TOYOTA JIDOSHA KABUSHIKI KAISHA, Toyota-shi (JP)

(21) Appl. No.: 19/419,349

(22) Filed: Dec. 15, 2025

(30) Foreign Application Priority Data
Jan. 14, 2025 (JP) 2025-004732

(51) Int. Cl. B23Q 17/22; B23Q 17/24

(52) U.S. Cl. CPC B23Q 17/22; B23Q 17/2409; B23Q 17/2428; B23Q 17/2442

(57) ABSTRACT

The present disclosure is a machining trajectory display system for displaying a machining trajectory of a machining tool, comprising: a marker mounted on the machining tool; one camera for imaging the marker; an information processing device for calculating a position of the machining tool based on image data of the marker captured by the camera, and calculating a machining trajectory of the machining tool based on the calculated position of the machining tool; and a trajectory display device for displaying the machining trajectory of the machining tool calculated by the information processing device, wherein the machining tool is attached with a support having a polyhedral shape, and the marker is attached to at least two surfaces of an outer surface of the support.

### CROSS-REFERENCE TO RELATED APPLICATION

This application claims priority to Japanese Patent Application No. 2025-004732 filed on January 14, 2025. The disclosure of the above-identified application, including the specification, drawings, and claims, is incorporated by reference herein in its entirety.

### BACKGROUND

### Technical Field

The present disclosure relates to a machining trajectory display system.

### Description of Related Art

Japanese Unexamined Patent Application Publication No. 2023-178692 (JP 2023-178692 A) discloses a machining trajectory display system including: a coordinate information acquisition device that acquires coordinate information of a machining tool including a machining unit; a leading end position information calculation unit that calculates position information of a leading end of the machining unit; and a trajectory calculation unit that calculates a machining trajectory of the machining tool based on the position information of the leading end of the machining unit.

### SUMMARY

In JP 2023-178692 A, the position of the machining tool is calculated by one coordinate information acquisition device (marker), and when the machining tool rotates to an attitude (angle) in which a camera cannot image the marker, the camera cannot image the marker and the position of the machining tool cannot be calculated in some cases.

The present disclosure provides a machining trajectory display system capable of calculating a position of a machining tool even when an attitude of the machining tool changes.

An aspect of the present disclosure provides a machining trajectory display system that displays a machining trajectory of a machining tool, including:

a marker attached to the machining tool;

one camera that images the marker;

an information processing device that calculates a position of the machining tool based on image data of the marker captured by the camera, and calculates the machining trajectory of the machining tool based on the calculated position of the machining tool; and a trajectory display device that displays the machining trajectory of the machining tool calculated by the information processing device, in which:

a polyhedral support is attached to the machining tool; and

the marker is attached to each of at least two of outer surface of the support.

With such a configuration, the position of the machining tool is calculated even when the posture of the machining tool changes.

The marker may include a fiducial marker and a reference marker; and the information processing device may calculate the position of the machining tool based on a position of the fiducial marker calculated based on image data of the fiducial marker captured by the camera and a position of the fiducial marker calculated based on image data of the reference marker captured by the camera. With such a configuration, even when a manufacturing error or the like occurs in the support, the position of the machining tool can be calculated more accurately by calculating the position of the machining tool based on the image data of the plurality of markers.

According to the present disclosure, it is possible to provide a machining trajectory display system that calculates a position of a machining tool even when an attitude of the machining tool changes.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a system configuration diagram of a machining trajectory display system according to an embodiment;

FIG. 2 is a schematic perspective view of a painting gun;

FIG. 3 is a schematic front view of a first marker;

FIG. 4 is a flowchart of a control program executed by the position calculation unit; and

FIG. 5 is a flowchart of a control program executed by the posture calculation unit.

### DETAILED DESCRIPTION OF EMBODIMENTS

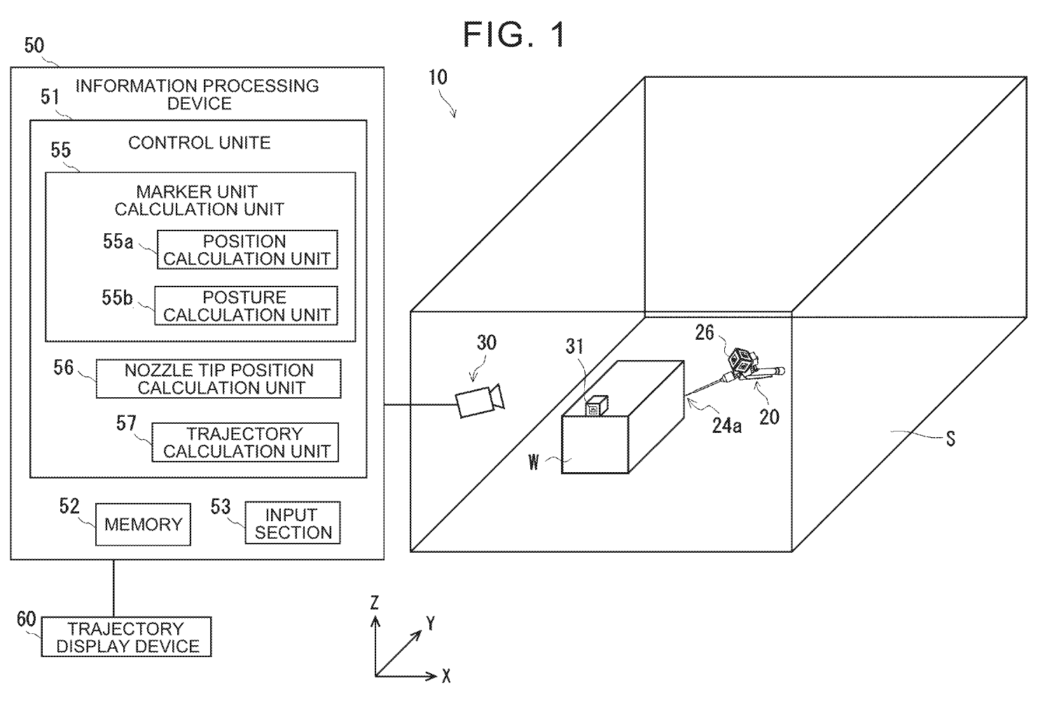

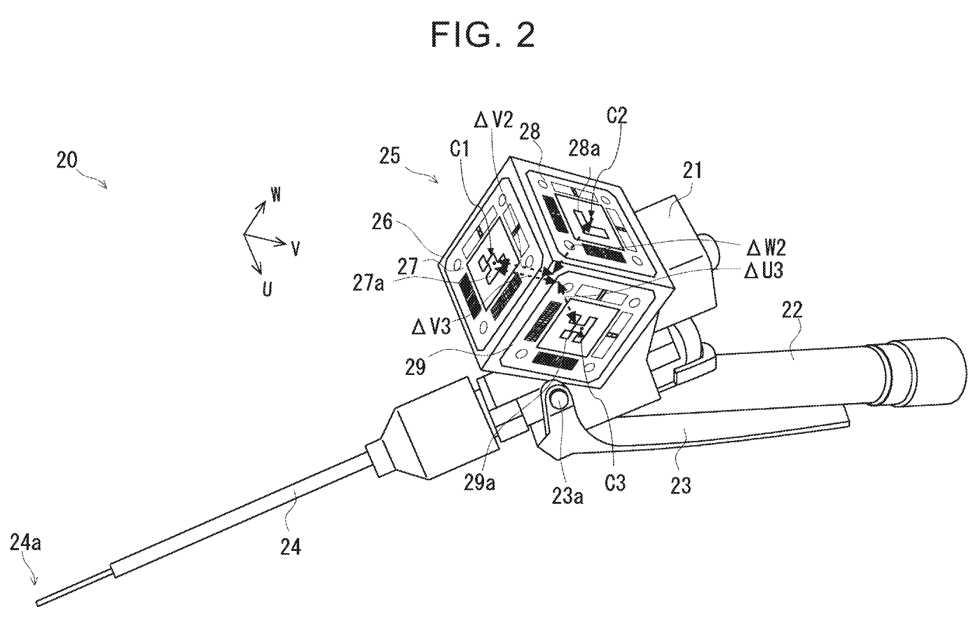

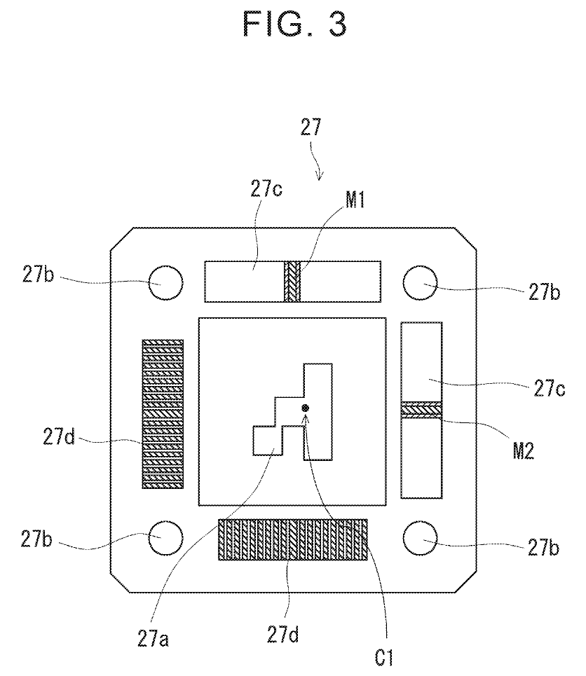

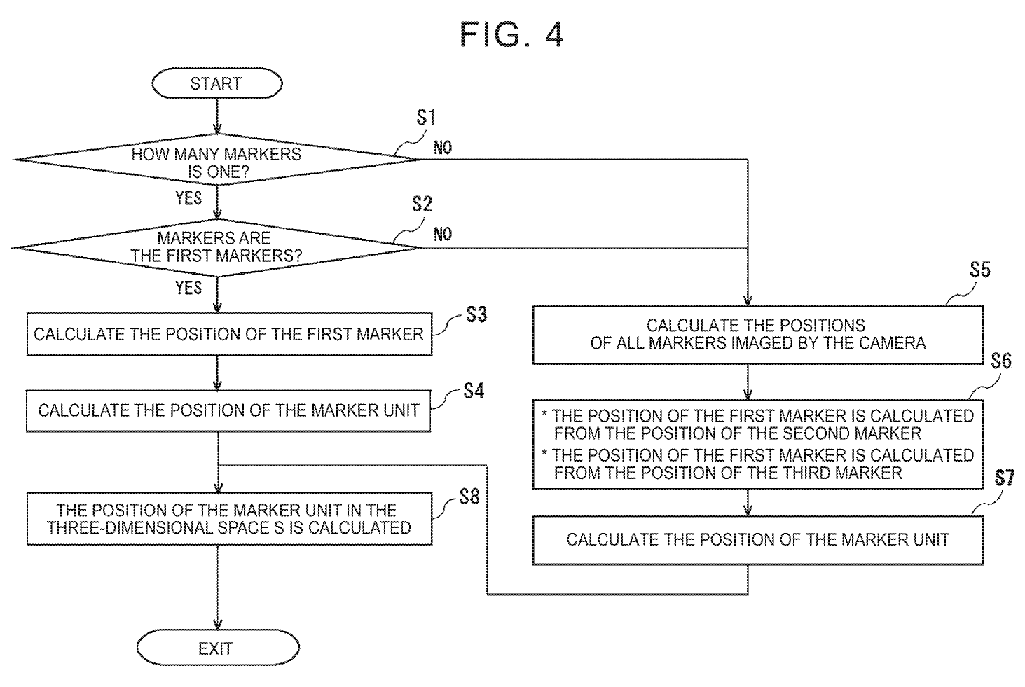

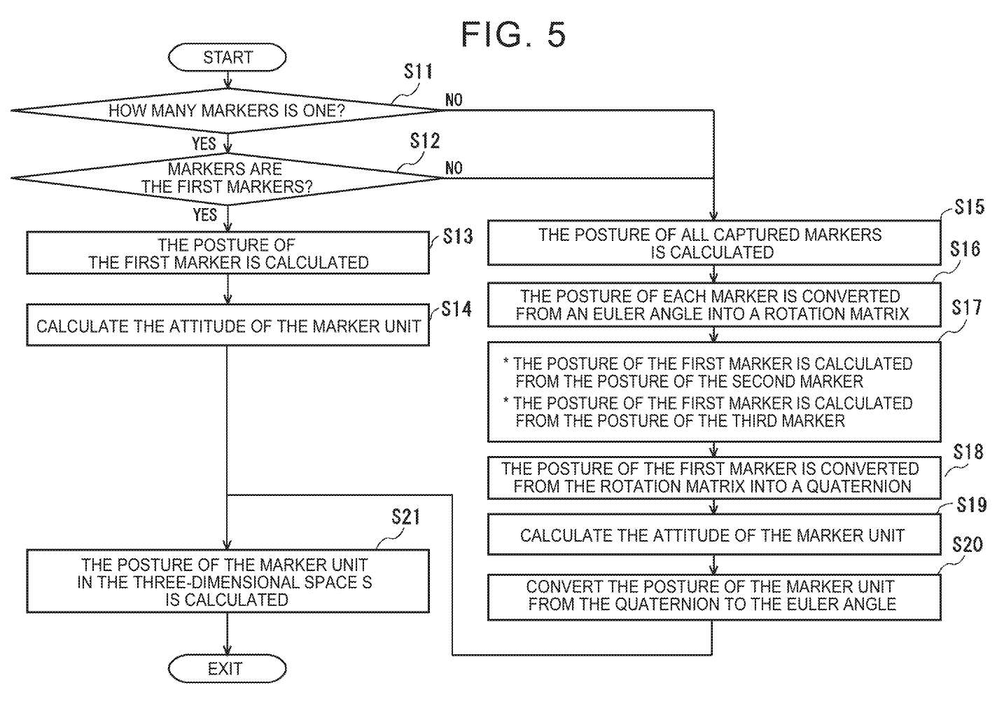

Hereinafter, an embodiment of the present disclosure will be described with reference to FIGS. 1 to 5. FIG. 1 is a system configuration diagram of a machining trajectory display system according to an embodiment. FIG. 2 is a schematic perspective view of a painting gun. FIG. 3 is a schematic front view of a first marker. FIG. 4 is a flowchart of a control program executed by the position calculation unit. FIG. 5 is a flowchart of a control program executed by the posture calculation unit.

### First Embodiment

A system configuration of the machining trajectory display system 10 according to the first embodiment will be described with reference to FIG. 1. The machining trajectory display system 10 is a system that calculates and displays a three-dimensional machining trajectory traced by the coating gun 20 when an operator (not shown) applies paint to an object to be painted (hereinafter, referred to as a workpiece) W using the coating gun 20 in the three-dimensional space S. The three-dimensional space S is a space that can be imaged by the camera 30, and is not limited to a space having a rectangular parallelepiped shape as shown in FIG. 1. The machining trajectory display system 10 includes a coating gun 20, a workpiece marker 31, a camera 30, an information processing device 50, and a trajectory display device 60.

As illustrated in FIG. 2, the coating gun 20, which is a machining tool, is a device that discharges a coating material to the workpiece W by, for example, electrostatic coating or spray coating. The coating gun 20 includes a body 21, a grip 22, a lever 23, and a nozzle 24. The body 21 is formed in a central portion of the coating gun 20, and a passage through which the coating material flows is provided inside the body. A paint hose (not shown) is connected to the body 21, and the paint is supplied from the paint hose to the body 21. The nozzle 24 is connected to one end of the body 21, and the paint is discharged from a nozzle tip 24a formed at the tip of the nozzle 24. The grip 22 is connected to an end portion on the other side of the body 21, and is a portion gripped by an operator. The lever 23 is attached to the body 21 via a hinge 23a. The lever 23 swings about the hinge shaft of the hinge 23a along the length of the coating gun 20. When the operator pulls the lever 23 toward the grip 22, the paint is discharged from the nozzle tip 24a.

In the embodiment, the three-dimensional machining trajectory traced by the coating gun 20 is calculated and displayed, but other machining tools may be used. Other machining tools include, for example, a welding torch used for welding, such as TIG welding, plasma welding, coated arc welding, MIG welding, or mag welding, or a caulking gun for sealing a member and a member. In addition, the length of the machining tool may be constant, or may be changed by wear, such as a welding torch.

As shown in FIG. 2, the marker unit 25 is attached to the body 21 of the coating gun 20. The marker unit 25 includes a support 26, a first marker 27, a second marker 28, and a third marker 29. The support 26 has a hexahedral shape and is made of a plastic material such as an ABS resin or a PLA resin. The support 26 is attached to the body 21 by attachment means (not shown). The first marker 27, the second marker 28, and the third marker 29 are respectively attached to three outer surfaces of the six outer surfaces of the support 26 adjacent to each other.

As shown in FIG. 3, the first marker 27 is formed in a flat plate shape having a substantially square shape in plan view and is made of a plastic material. The first marker 27 includes an identification portion 27a, a reference portion 27b, a variable moiré pattern portion 27c, and a flip detection pattern portion 27d.

The identification portion 27a is formed in a central portion of the first marker 27 and is formed of a matrix-type two-dimensional code. The identification portion 27a is used to identify a plurality of markers.

The reference portion 27b is formed at four corners of the first marker 27 and is formed by a circular mark. The reference portion 27b is used to detect the position and orientation of the marker unit 25 because the positional relation between the four circular marks and the four circular marks captured from the camera 30 changes depending on the angle and the position of the first marker 27.

The variable moiré pattern portion 27c is formed between two adjacent sides of the first marker 27 and the reference portion 27b. The variable moiré pattern portion 27c is constituted by a lens array in which a plurality of lenses is arranged on a black-and-white striped pattern. The variable moiré pattern portion 27c is used to detect the attitude of the marker unit 25 because the position of the mark M1, M2 captured by the camera 30 varies depending on the angle of the first marker 27.

The flip detection pattern portion 27d is two sides other than the two sides on which the variable moiré pattern portion 27c of the first marker 27 is formed, and is formed between the reference portions 27b. The flip detection pattern portion 27d is composed of a plurality of triangular prisms arranged along one side of the first marker 27, and the plurality of triangular prisms are painted in black and white between adjacent side surfaces. The flip detection pattern portion 27d is used to detect the attitude of the marker unit 25 because the black-and-white pattern captured by the camera 30 is inverted by the angle of the first marker 27.

The second marker 28 and the third marker 29 have the same basic structure and function as those of the first marker 27, but differ in the structure of the identification unit. As illustrated in FIG. 2, the identification portion 27a of the first marker 27, the identification portion 28a of the second marker 28, and the identification portion 29a of the third marker 29 differ from each other in the matrix-type two-dimensional code pattern. With such a configuration, it is possible to identify which marker the marker captured by the camera 30 is. In the embodiment, the support 26 and each marker are separate bodies, but may be integrated. The number of markers attached to the support 26 may be two or four or more.

As illustrated in FIG. 1, the machining trajectory display system 10 includes a workpiece marker 31. The workpiece marker 31 is placed at a position that is not hidden behind the operator as viewed from the camera 30 when the operator applies the paint to the workpiece W using the coating gun 20. The basic structure and function of the workpiece marker 31 are the same as those of the first marker 27, but the structure of the identification unit is different. The pattern of the matrix-type two-dimensional code of the identification unit of the workpiece marker 31 is different from the pattern of the identification unit of each of the first marker 27, the second marker 28, and the third marker 29. With such a configuration, the workpiece marker 31 and the other markers can be identified. The position and orientation of the workpiece marker 31 in the three-dimensional space S are grasped in advance, and are used to calculate the position and orientation of the marker unit 25 in the three-dimensional space S. The position and orientation of the workpiece marker 31 in the three-dimensional space S are stored in a memory 52 described later.

As illustrated in FIG. 1, the machining trajectory display system 10 includes one camera 30. As the camera 30, a high-speed camera, a Web camera, a FA camera, or the like is used. The camera 30 is fixed at a predetermined position, and captures an image of the marker unit 25 and the workpiece marker 31 attached to the coating gun 20 when an operator applies a coating material to the workpiece W using the coating gun 20. Specifically, the camera 30 images the first marker 27, the second marker 28, and the third marker 29 of the marker unit 25 and the workpiece marker 31. The camera 30 transmits the captured image data such as the first marker 27 to the information processing device 50. The camera 30 may include a light for irradiating the three-dimensional space S with light.

The information processing device 50 includes a computer, and includes a control unit 51, a memory 52, and an input unit 53. The control unit 51 includes CPU (Central Processing Unit) and the like, and calculates the position of the coating gun 20. The memories 52 include RAM (Random Access Memory), ROM (Read Only Memory), and the like, and store control programs and the like executed by the control unit 51. The input unit 53 includes a keyboard, a touch panel, and the like, and inputs data and the like related to the marker unit 25.

The control unit 51 includes a marker unit calculation unit 55, a nozzle tip position calculation unit 56, and a trajectory calculation unit 57. The marker unit calculation unit 55 includes a position calculation unit 55a and a posture calculation unit 55b.

The position calculation unit 55a calculates the position (Xm, Ym, Zm) of the marker unit 25 in the three-dimensional space S based on the image data of the first marker 27, the second marker 28, the third marker 29, and the workpiece marker 31 transmitted from the camera 30. As shown in FIG. 1, XYZ coordinates (one direction in the horizontal direction is an X-axis, a direction perpendicular to the X-axis is a Y-axis, and a vertical direction is a Z-axis) are set in the three-dimensional space S, and the position calculation unit 55a calculates the position of the marker unit 25 with XYZ coordinates.

As shown in FIG. 2, the positions of the three markers attached to the support 26 are different from each other. Therefore, even when the marker units 25 are at the same position, the positions of the respective markers indicate different values. In the first embodiment, the position (X1, Y1, Z1) of the first marker 27 is set as the reference marker and the position (Xm, Ym, Zm) of the marker unit 25 is set as the first marker 27. A marker other than the reference marker (the second marker 28 and the third marker 29) is a reference marker, and the position of the first marker 27 is calculated from the position of the reference marker so that the position of the marker unit 25 can also be calculated from the position of the reference marker. A specific calculation method will be described later.

The posture calculation unit 55b calculates the posture (Roll_m, Pitch_m, Yaw_m) of the marker unit 25 in the three-dimensional space S based on the image data of the first marker 27, the second marker 28, the third marker 29, the workpiece marker 31, and the like transmitted from the camera 30. In the first embodiment, the attitude (angle) of the marker unit 25 is represented by three Roll, Pitch, and Yaw variables called Euler angles.

Also in the posture calculation unit 55b, the posture (Roll1, Pitch1, Yaw1) of the first marker 27 is set as the reference marker and the posture (Roll_m, Pitch_m, Yaw_m) of the marker unit 25 is set as the first marker 27. A specific method of calculating the posture of the first marker 27 from the postures of the reference markers (the second marker 28 and the third marker 29) will be described later.

Next, a position calculation program of the marker unit 25 executed by the position calculation unit 55a at a predetermined cycle will be described. FIG. 4 shows a flowchart of a position calculation program of the marker unit 25 executed by the position calculation unit 55a.

In S1, based on the image data of the first marker 27 and the like transmitted from the camera 30, it is determined whether or not there is one (one or more) marker of the marker unit 25 imaged by the camera 30. The number of markers of the marker unit 25 imaged by the camera 30 varies depending on the position and orientation of the coating gun 20. The position calculation unit 55a determines the number of markers based on the number of identifying units of the markers of the marker unit 25 included in the image data. When the number of markers in the marker unit 25 is one, the process proceeds to S2, and when there is a plurality of markers, the process proceeds to S5.

In S2, it is determined whether or not the marker of the marker unit 25 captured by the camera 30 is the first marker 27. The pattern of the two-dimensional code displayed on the identification unit of each marker is stored in advance in the memory 52. Therefore, the position calculation unit 55a compares the pattern of the two-dimensional code of the identification unit of the marker of the marker unit 25 captured by the camera 30 with the pattern of the two-dimensional code of the identification unit of each marker stored in the memory 52. Then, the position calculation unit 55a determines whether or not the marker of the marker unit 25 captured by the camera 30 is the first marker 27. When the marker is the first marker 27, the process proceeds to S3, and when the marker is the other marker, the process proceeds to S5.

In S3, the position (X1, Y1, Z1) of the first marker 27 is calculated based on the image data of the first marker 27 and the like transmitted from the camera 30. The position calculation unit 55a calculates the position (X1, Y1, Z1) of the first marker 27 based on the shapes of the four circular marks constituting the reference portion 27b of the first marker 27, the positional relation of the four circular marks, and the like. In the first embodiment, the center C1 (see FIG. 2) of the first marker 27 is set as the position (X1, Y1, Z1) of the first marker 27. The position of the first marker 27 calculated by S3 is a tentative value, and the position of the marker unit 25 in the three-dimensional space S is calculated based on the position of the workpiece marker 31 calculated in the subsequent steps.

In S4, the position (Xma, Yma, Zma) of the marker unit 25 is calculated based on the position (X1, Y1, Z1) of the first marker 27 calculated by S3. As described above, in the first embodiment, the position of the first marker 27 is set as the reference marker and the position of the first marker 27 is set as the position of the marker unit 25. Therefore, in S4, the position (X1, Y1, Z1) of the first marker 27 calculated by S3 is set to the position (Xma, Yma, Zma) of the marker unit 25. The position of the marker unit 25 calculated by S4 is a tentative value, and the position of the marker unit 25 in the three-dimensional space S is calculated based on the position of the workpiece marker 31 calculated in the subsequent steps.

In S5, the positions of all the markers of the marker unit 25 captured by the camera 30 are calculated based on the image data of the first marker 27 and the like transmitted from the camera 30. For example, when the camera 30 is able to image all the markers of the marker unit 25, the position (X1, Y1, Z1) of the first marker 27, the position (X2, Y2, Z2) of the second marker 28, and the position (X3, Y3, Z3) of the third marker 29 are respectively calculated. When the camera 30 is able to image any two markers of the marker unit 25, the positions of the two captured markers are calculated. When the camera 30 is able to capture only the second marker 28 or the third marker 29, the position of the second marker 28 or the third marker 29 is calculated. The position of the second marker 28 and the position of the third marker 29 are calculated in the same manner as the position of the first marker 27 calculated by S3. The position of the first marker 27 or the like calculated by S5 is a tentative value, and the position of the marker unit 25 in the three-dimensional space S is calculated based on the position of the workpiece marker 31 calculated in the subsequent steps.

In S6, the position of the first marker 27 is calculated from the position (X2, Y2, Z2) of the second marker 28 calculated by S5 or the position (X3, Y3, Z3) of the third marker 29. As described above, the position of the first marker 27 is calculated from the position of the second marker 28 or the third marker 29 so that the position of the marker unit 25 can also be calculated from the positions of the reference markers (the second marker 28 and the third marker 29).

First, the position of the first marker 27 is calculated from the position of the second marker 28. As illustrated in FIG. 2, when UVW coordinates in the three-dimensional direction are set with respect to the marker unit 25, the center C1 of the first marker 27 and the center C2 of the second marker 28 are separated in the W-axis direction by ΔW2 and the V-axis direction by ΔV2. The ΔW2 and ΔV2 are stored in the memory 52 in advance. The position calculation unit 55a converts ΔW2 and ΔV2 into XYZ coordinates, and moves the position (X2, Y2, Z2) of the second marker 28 by ΔW2 and ΔV2 converted into XYZ coordinates to calculate the position of the first marker 27. The position of the first marker 27 calculated from the position (X2, Y2, Z2) of the second marker 28 is referred to as (X2', Y2', Z2′).

Subsequently, the position of the first marker 27 is calculated from the position of the third marker 29. As shown in FIG. 2, the center C1 of the first marker 27 and the center C3 of the third marker 29 are separated in the U-axis direction by ΔU3 and the V-axis direction by ΔV3. The ΔU3 and ΔV3 are stored in the memory 52 in advance. The position calculation unit 55a converts ΔU3 and ΔV3 into XYZ coordinates, and moves the position (X3, Y3, Z3) of the third marker 29 by ΔU3 and ΔV3 converted into XYZ coordinates to calculate the position of the first marker 27. The position of the first marker 27 determined from the position (X3, Y3, Z3) of the third marker 29 is (X3', Y3', Z3′). When one of the second marker 28 and the third marker 29 is not captured by the camera 30, in S6, the position of the first marker 27 from the position of the marker that is not captured is not calculated.

Subsequently, in S7, the position (X1, Y1, Z1) of the first marker 27 and the position (Xma, Yma, Zma) of the marker unit 25 are calculated. The position (X1, Y1, Z1) of the first marker 27 was calculated by S5. The position (Xma, Yma, Zma) of the marker unit 25 was calculated in S6 based on the position (X2', Y2', Z2′) and (X3', Y3', Z3′) of the first marker 27.

Specifically, when the camera 30 is able to image all the markers of the marker unit 25, the averages of (X1, Y1, Z1), (X2', Y2', Z2′), and (X3', Y3', Z3′) are set as the position (Xma, Yma, Zma) of the marker unit 25. When the camera 30 is able to image any two markers of the marker unit 25, the mean of the positions of the two first markers 27 calculated from the captured markers is taken as the position (Xma, Yma, Zma) of the marker unit 25. When the camera 30 is capable of imaging only the second marker 28 or the third marker 29, the position (X2', Y2', Z2′) or (X3', Y3', Z3′) is set as the position (Xma, Yma, Zma) of the marker unit 25. The position of the marker unit 25 calculated by S7 is a tentative value, and the position of the marker unit 25 in the three-dimensional space S is calculated based on the position of the workpiece marker 31 calculated in the subsequent steps.

In S8, the position (Xm, Ym, Zm) of the marker unit 25 in the three-dimensional space S is calculated based on the position (Xma, Yma, Zma) of the marker unit 25 calculated by S4 or S7. Specifically, the position (Xw, Yw, Zw) of the workpiece marker 31 is calculated based on the image data of the workpiece marker 31 transmitted from the camera 30. The position of the workpiece marker 31 is calculated in the same manner as the position of the first marker 27 calculated by S3. Subsequently, the difference (ΔXw, ΔYw, ΔZw) between the calculated position of the workpiece marker 31 and the position of the workpiece marker 31 in the three-dimensional space S stored in the memory 52 is calculated. Then, the position (Xm, Ym, Zm) of the marker unit 25 in the three-dimensional space S is calculated based on the position (Xma, Yma, Zma) and the difference (ΔXw, ΔYw, ΔZw) of the marker unit 25 calculated by S4 or S7.

Next, an attitude calculation program of the marker unit 25 executed by the posture calculation unit 55b at a predetermined cycle will be described. The timing of calculating the attitude of the marker unit 25 executed by the posture calculation unit 55b is the same as the timing of calculating the position of the marker unit 25 executed by the position calculation unit 55a. That is, the position and the posture of the marker unit 25 are calculated at predetermined timings. FIG. 5 shows a flowchart of a program for calculating the attitude of the marker unit 25 executed by the posture calculation unit 55b.

In S11, based on the image data of the first marker 27 and the like transmitted from the camera 30, it is determined whether or not there is one (one or more) marker of the marker unit 25 imaged by the camera 30. S11 is the same as S1 of the flowchart of FIG. 4 executed by the position calculation unit 55a, and will not be described. When the number of markers in the marker unit 25 is one, the process proceeds to S12, and when there is a plurality of markers, the process proceeds to S15.

In S12, it is determined whether or not the marker of the marker unit 25 captured by the camera 30 is the first marker 27. S12 is the same as S2 of the flowchart of FIG. 4 executed by the position calculation unit 55a, and will not be described. When the marker is the first marker 27, the process proceeds to S13, and when the marker is the other marker, the process proceeds to S15.

In S13, the attitude (Roll1, Pitch1, Yaw1) of the first marker 27 is calculated based on the image data of the first marker 27 captured by the camera 30. The posture calculation unit 55b calculates the posture (Roll1, Pitch1, Yaw1) of the first marker 27 based on the mark M1, the position of M2, the black-and-white pattern represented by the flip detection pattern portion 27d, and the like. The positions of the marks M1 and M2 are represented by the variable moiré pattern portions 27c of the first markers 27. The posture of the first marker 27 calculated by S13 is a tentative value, and the posture of the marker unit 25 in the three-dimensional space S is calculated based on the posture of the workpiece marker 31 calculated in the subsequent steps.

In S14, the posture (Roll_ma, Pitch_ma, Yaw_ma) of the marker unit 25 is calculated based on the posture (Roll1, Pitch1, Yaw1) of the first marker 27 calculated by S3. As described above, in the first embodiment, the posture of the first marker 27 is the posture of the marker unit 25, and the posture of the first marker 27 is the reference marker. Therefore, in S14, the posture (Roll1, Pitch1, Yaw1) of the first marker 27 calculated by S13 is set to the posture (Roll_ma, Pitch_ma, Yaw_ma) of the marker unit 25. The posture of the marker unit 25 calculated by S14 is a tentative value, and the posture of the marker unit 25 in the three-dimensional space S is calculated based on the posture of the workpiece marker 31 calculated in the subsequent steps.

In S15, the attitude of all the markers of the marker unit 25 captured by the camera 30 is calculated based on the image data of the first marker 27 and the like transmitted from the camera 30. For example, when the camera 30 is able to image all the markers of the marker unit 25, the posture (Roll1, Pitch1, Yaw1) of the first marker 27, the posture (Roll2, Pitch2, Yaw2) of the second marker 28, and the posture (Roll3, Pitch3, Yaw3) of the third marker 29 are respectively calculated. When the camera 30 is able to image any two markers of the marker unit 25, the posture of the two captured markers is calculated. When the camera 30 is able to capture only the second marker 28 or the third marker 29, the posture of the second marker 28 or the third marker 29 is calculated. The posture of the second marker 28 and the posture of the third marker 29 are calculated in the same manner as the posture of the first marker 27 calculated by S13. The posture of the first marker 27 or the like calculated by S15 is a tentative value, and the posture of the marker unit 25 in the three-dimensional space S is calculated based on the posture of the workpiece marker 31 calculated in the subsequent steps.

In S16, in order to avoid the so-called gimbal-lock phenomena, the positions of the respective markers calculated by S15 are converted from the Euler angle to the rotational matrix by known methods. The posture of the first marker 27 after conversion into the rotational matrix is represented by R1, the posture of the second marker 28 is represented by R2, and the posture of the third marker 29 is represented by R3.

In S17, the posture of the first marker 27 is calculated from the posture R2 of the second marker 28 or the posture R3 of the third marker 29. As described above, the posture of the first marker 27 is calculated from the posture of the second marker 28 or the third marker 29 so that the posture of the marker unit 25 can also be calculated from the posture of the reference marker (the second marker 28 and the third marker 29).

First, the posture of the first marker 27 is calculated from the posture of the second marker 28. In UVW coordinate shown in FIG. 2, when the second marker 28 is rotated by 90° about the U-axis, the posture of the first marker 27 is obtained. The relationship between the relative postures of the first marker 27 and the second marker 28 is stored in the memory 52 in advance. The posture calculation unit 55b converts the U-axis into XYZ coordinates and rotates 90° about the U-axis converted into XYZ coordinates with respect to the posture R2 of the second marker 28 to calculate the posture of the first marker 27. The posture of the first marker 27 obtained from the posture R2 of the second marker 28 is taken as an R2'.

Subsequently, the posture of the first marker 27 is calculated from the posture of the third marker 29. In UVW coordinate shown in FIG. 2, when the third marker 29 is rotated by 90° about the W-axis, the posture of the first marker 27 is obtained. The relationship between the relative postures of the first marker 27 and the third marker 29 is stored in the memory 52 in advance. Then, the posture calculation unit 55b converts the W-axis into XYZ coordinates, and rotates 90° about the W-axis converted into XYZ coordinates with respect to the posture R3 of the third marker 29 to calculate the posture of the first marker 27. The posture of the first marker 27 obtained from the posture R3 of the third marker 29 is taken as an R3'. When one of the second marker 28 and the third marker 29 is not captured by the camera 30, the posture of the first marker 27 is not calculated from the posture of the marker that is not captured by S17.

In S18, the posture R1 of the first marker 27 converted by S16, the posture R2' of the first marker calculated by S17, and R3' are converted from the rotational matrix into quaternions by known methods so that the mean can be calculated by a S19 to be described later. After the conversion to the quaternion, the orientation of the first marker 27 calculated from the images of the first marker 27 is represented by Qt1. Note that the posture of the first marker 27 calculated from the posture of the second marker 28 after the conversion to the quaternion is represented by Qt2. Note that the posture of the first marker 27 calculated from the posture of the third marker 29 after the conversion to the quaternion is represented by Qt3.

In S19, the attitude Qt_ma of the marker unit 25 is calculated based on the attitude Qt1, Qt2, Qt3 of the first marker 27 converted by S18.

Specifically, when the camera 30 is able to image all the markers of the marker unit 25, the averages of Qt1, Qt2, and Qt3 are set as the attitude Qt_ma of the marker unit 25. When the camera 30 is able to image any two markers of the marker unit 25, the average value of the postures of the two first markers 27 calculated from the captured markers is set as the posture Qt_ma of the marker unit 25. When the camera 30 is able to image only the second marker 28 or the third marker 29, Qt2 or Qt3 is set as the attitude Qt_ma of the marker unit 25. The posture of the marker unit 25 calculated by S19 is a tentative value, and the posture of the marker unit 25 in the three-dimensional space S is calculated based on the posture of the workpiece marker 31 calculated in the subsequent steps.

In S20, the attitude Qt_ma of the marker unit 25 calculated by S19 is converted from the quaternion to the Euler angle (Roll_ma, Pitch_ma, Yaw_ma) by a known method.

In S21, the attitude (Roll_m, Pitch_m, Yaw_m) of the marker unit 25 in the three-dimensional space S is calculated based on the attitude (Roll_ma, Pitch_ma, Yaw_ma) of the marker unit 25 calculated by S14 or S20. Specifically, the posture (Roll_w, Pitch_w, Yaw_w) of the workpiece marker 31 is calculated based on the image data of the workpiece marker 31 transmitted from the camera 30. The posture of the workpiece marker 31 is calculated in the same manner as the posture of the first marker 27 calculated by S13. Subsequently, the difference (ΔRoll_w, ΔPitch_w, ΔYaw_w) between the calculated posture of the workpiece marker 31 and the posture of the workpiece marker 31 in the three-dimensional space S stored in the memory 52 is calculated. Then, the attitude (Roll_m, Pitch_m, Yaw_m) of the marker unit 25 in the three-dimensional space S is calculated based on the attitude (Roll_ma, Pitch_ma, Yaw_ma) and the difference (ΔRoll_w, ΔPitch_w, ΔYaw_w) of the marker unit 25 calculated by S14 or S20.

Next, the position calculation of the nozzle tip 24a of the coating gun 20 performed by the nozzle tip position calculation unit 56 at a predetermined cycle will be described. In the first embodiment, the three-dimensional machining trajectory traced by the nozzle tip 24a of the coating gun 20 is displayed. Therefore, the nozzle tip position calculation unit 56 calculates the position of the nozzle tip 24a based on the position of the marker unit 25 calculated by the position calculation unit 55a and the posture of the marker unit 25 calculated by the posture calculation unit 55b.

As illustrated in FIG. 2, the relative positional relation between the marker unit 25 and the nozzle tip 24a can be grasped in advance. For example, in UVW coordinate shown in FIG. 2, when the center C1 of the first marker 27 and the nozzle tip 24a are separated by ΔUN in the U-axis direction, ΔVN in the V-axis direction, and ΔWN in the W-axis direction, the ΔUN, ΔVN, and ΔWN are stored in advance in the memory 52. The nozzle tip position calculation unit 56 converts ΔUN, ΔVN, and ΔWN into XYZ coordinates on the basis of the attitude (Roll_m, Pitch_m, Yaw_m) of the marker unit 25 calculated by the posture calculation unit 55b. It is assumed that ΔUN, ΔVN, and ΔWN converted into XYZ coordinates are respectively ΔXN, ΔYN, and ΔZN. Then, the nozzle tip position calculation unit 56 moves the position (Xm, Ym, Zm) of the marker unit 25 calculated by the position calculation unit 55a by ΔXN, ΔYN, and ΔZN to calculate the position (Xn, Yn, Zn) of the nozzle tip 24a.

The trajectory calculation unit 57 calculates the machining trajectory of the nozzle tip 24a based on the position (Xn, Yn, Zn) of the nozzle tip 24a calculated by the nozzle tip position calculation unit 56. In the nozzle tip position calculation unit 56, the position calculation of the nozzle tip 24a is performed at a predetermined cycle. The trajectory calculation unit 57 acquires the position of the nozzle tip 24a calculated by the nozzle tip position calculation unit 56 each time, and calculates the three-dimensional machining trajectory traced by the nozzle tip 24a.

The trajectory display device 60 displays the three-dimensional machining trajectory of the nozzle tip 24a calculated by the trajectory calculation unit 57. As a device to be displayed, a display, a monitor, or the like is used.

In the first embodiment, a support 26 having a hexahedral shape is attached to the body 21 of the coating gun 20. Of the six outer surfaces of the support 26, the first marker 27, the second marker 28, and the third marker 29 are respectively attached to three outer surfaces. With such a configuration, the camera 30 can image the second marker 28 or the third marker 29 even when the coating gun 20 rotates in a posture (angle) in which the camera 30 cannot image the first marker 27. Then, the information processing device 50 can calculate the position of the coating gun 20 from the image data of the second marker 28 or the third marker 29 captured by the camera 30.

In Embodiment 1, the reference marker (first marker 27) and the reference markers (second marker 28 and third marker 29) are included. The information processing device 50 calculates the position (X1, Y1, Z1) of the first marker 27 calculated based on the image data of the first marker 27. The information processing device 50 calculates the position (Xm, Ym, Zm) of the marker unit 25 by averaging the position (X2', Y2', Z2′) or (X3', Y3', Z3′) of the first marker 27 calculated based on the image data of the second marker 28 or the third marker 29. With such a configuration, even when a manufacturing error or the like occurs in the support 26, the position of the marker unit 25 can be calculated more accurately by calculating the position of the marker unit 25 based on the image data of the plurality of markers.

The present disclosure is not limited to the above-described embodiments, and can be appropriately modified without departing from the scope of the present disclosure.

For example, the support is not limited to a hexahedron, and may be other polyhedrons such as a tetrahedron or an octahedron.

In the embodiment, the three-dimensional machining trajectory traced by the nozzle tip of the coating gun is displayed, but the machining trajectory traced by the other portion may be displayed instead of the tip. Further, the machining trajectory may be calculated and displayed including not only the position but also the posture.

What is claimed is:

1. A machining trajectory display system that displays a machining trajectory of a machining tool, comprising:
a marker attached to the machining tool;
one camera that images the marker;
an information processing device that calculates a position of the machining tool based on image data of the marker captured by the camera, and calculates the machining trajectory of the machining tool based on the calculated position of the machining tool; and
a trajectory display device that displays the machining trajectory of the machining tool calculated by the information processing device, wherein:
a polyhedral support is attached to the machining tool; and
the marker is attached to each of at least two of outer surface of the support.

2. The machining trajectory display system according to claim 1, wherein:
the marker includes a fiducial marker and a reference marker; and
the information processing device calculates the position of the machining tool based on a position of the fiducial marker calculated based on image data of the fiducial marker captured by the camera and a position of the fiducial marker calculated based on image data of the reference marker captured by the camera.
